(19) United States
(12) Patent Application Publication
(10) Pub. No.: US 2019/0037658 A1
(43) Pub. Date: Jan. 31, 2019

(54) ILLUMINATION ELEMENT BLANKET SYSTEM

(71) Applicant: Just Funky LLC, Richfield, OH (US)

(72) Inventors: Gertrude LaDouceur, Delaware, OH (US); Shivani Arora, Wooster, OH (US)

(21) Appl. No.: 15/663,194

(22) Filed: Jul. 28, 2017

(51) Int. Cl. H05B 33/08; H05B 37/02; F21V 33/00; F21V 23/02; A47G 9/02

(52) U.S. Cl. CPC H05B 33/0845; H05B 37/0281; F21Y 2115/10; F21V 23/02; A47G 9/0223; F21V 33/0024

(57) ABSTRACT

Articles of manufacture, systems and methods facilitating light emitting diode (LED) blankets are provided herein. In one embodiment, an article of manufacture comprises: a first layer of fabric; a second layer of fabric; and circuitry disposed between the first layer of fabric and the second layer of fabric, the circuitry comprising: at least one light emitting diode; and a control device coupled to the at least one light emitting diode, wherein the control device is configured to control illumination of the at least one light emitting diode. In some embodiments, the system further comprises a power source coupled to the control device and configured to provide power to the control device and the at least one light emitting diode. In some embodiments, the power source is removably coupled to the circuitry, and comprises a battery pack.

### TECHNICAL FIELD

The subject disclosure relates generally to blankets and, for example, to systems, apparatus and methods facilitating blankets having illumination elements.

### BRIEF DESCRIPTION OF THE DRAWINGS

FIGS. 1A, 1B, and 1C illustrate example, non-limiting partial views of schematic diagrams of illumination element blanket systems (IEBSs) in accordance with one or more embodiments described herein.

FIG. 2 illustrates an example, non-limiting schematic diagram of a side view of an illumination element blanket system (IEBS) in accordance with one or more embodiments described herein.

FIGS. 3A and 3B illustrate example, non-limiting block diagrams of a control device of an IEBS in accordance with one or more embodiments described herein.

FIGS. 4, 5, 6 and 7 illustrate example, non-limiting photographs of an IEBS having a hole disposed through an outer layer of fabric revealing inside construction and selected components in accordance with one or more embodiments described herein.

FIGS. 7A and 7B illustrate example, non-limiting photographs of IEBSs in accordance with one or more embodiments described herein.

FIGS. 8 and 9 illustrate flow charts of methods of operation of an IEBS in accordance with one or more embodiments described herein.

FIG. 10 illustrates a block diagram of a computer that can be employed in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a circuitry-related entity, an entity powered by one or more power sources, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, an integrated circuit, one or more circuit components, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer, control unit, power source or one or more illumination elements to implement the disclosed subject matter. The term “article of manufacture” as used herein is intended to encompass, but is not limited to, a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the terms “device,” “component,” “system,” “communication device,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

One or more embodiments described herein comprises an article of manufacture (AOM). The AOM can comprise: a first layer of fabric; a second layer of fabric; and circuitry disposed between the first layer of fabric and the second layer of fabric, the circuitry comprising: at least one light emitting diode; and a control device coupled to the at least one light emitting diode, wherein the control device is configured to control illumination of the at least one light emitting diode. In some embodiments, the AOM further comprises a power source coupled to the control device and configured to provide power to the control device and the at least one light emitting diode. In some embodiments, the power source is removably coupled to the circuitry and/or comprises a battery pack. The battery pack can be configured with a switch that controls the battery pack to provide power to the control device and the at least one light emitting diode.

In some embodiments, the AOM further comprises a power connection component coupled to the control device, wherein the power connection component is configured to be removably coupled to a power source external to the article of manufacture to provide power to the control device and the at least one light emitting diode.

In some embodiments, the AOM further comprises at least one other light emitting diode, wherein the control device is configured to output a signal causing the at least one light emitting diode and the at least one other light emitting diode to have staggered illumination, wherein the staggered illumination comprises the at least one light emitting diode commencing illuminating at a first time and the at least one other light emitting diode commencing illumination at a second time, wherein the second time is later than the first time. In some embodiments, the control device is configured to output a signal causing the at least one light emitting diode and the at least one other light emitting diode to illuminate. In some embodiments, the control device comprises a power shut off component configured to automatically shut off power from the battery pack. The power shut off component is further configured to automatically shut off power from the battery pack after a defined amount of time that the battery pack has been turned on

In various embodiments, the first layer of fabric is an outer layer of fabric that comprises at least one of sherpa, velveteen, fleece, wool, acrylic, cotton or polyester. The AOM can further comprise a third layer of fabric positioned between the first layer and the second layer, wherein the light emitting diode is attached to the third layer of fabric. In some embodiments, the light emitting diode is attached to the third layer of fabric via adhesive.

One or more other embodiments can comprise a method of operation. The method of operation can comprise: controlling, by a control device comprising a processor, provisioning of first power to a first light emitting diode positioned on or within a blanket having a first layer and a second layer, wherein provisioning of the first power causes the first light emitting diode to become illuminated; and controlling, by the control device, provisioning of second power to a second light emitting diode positioned on or within the blanket, wherein provisioning of the second power causes the second light emitting diode to become illuminated, wherein the first power and the second power are emitted from a battery pack removably coupled to the first light emitting diode and the second light emitting diode.

In some embodiments, the controlling the provisioning the first power and the controlling the provisioning of the second power causes the first light emitting diode and the second light emitting diode to be powered on concurrently. In some embodiments, the controlling the provisioning the first power and the controlling the provisioning of the second power causes the first light emitting diode to be powered on during a first time period and causes the second light emitting diode to be powered on during a second time period, wherein the first time period and the second time period are non-overlapping.

In some embodiments, the method can comprise generating, by the control device, a signal to cause the battery pack to power down after a defined amount of time of operation of the battery pack.

One or more other embodiments can comprise a system comprising: a fabric having a plurality of illumination elements configured to illuminate and disposed on or within the fabric; and a power source coupled to a plurality of electrical connections respectively coupled to the plurality of illumination elements to provide power to the illumination elements, wherein the power source is configured to illuminate one or more of the plurality of illumination elements concurrently.

In some embodiments, the power source is coupled to a switch that causes the power source to provide power to one or more of the plurality of illumination elements and to cease providing power to the one or more of the plurality of illumination elements. In some embodiments, the illumination elements are light emitting diodes.

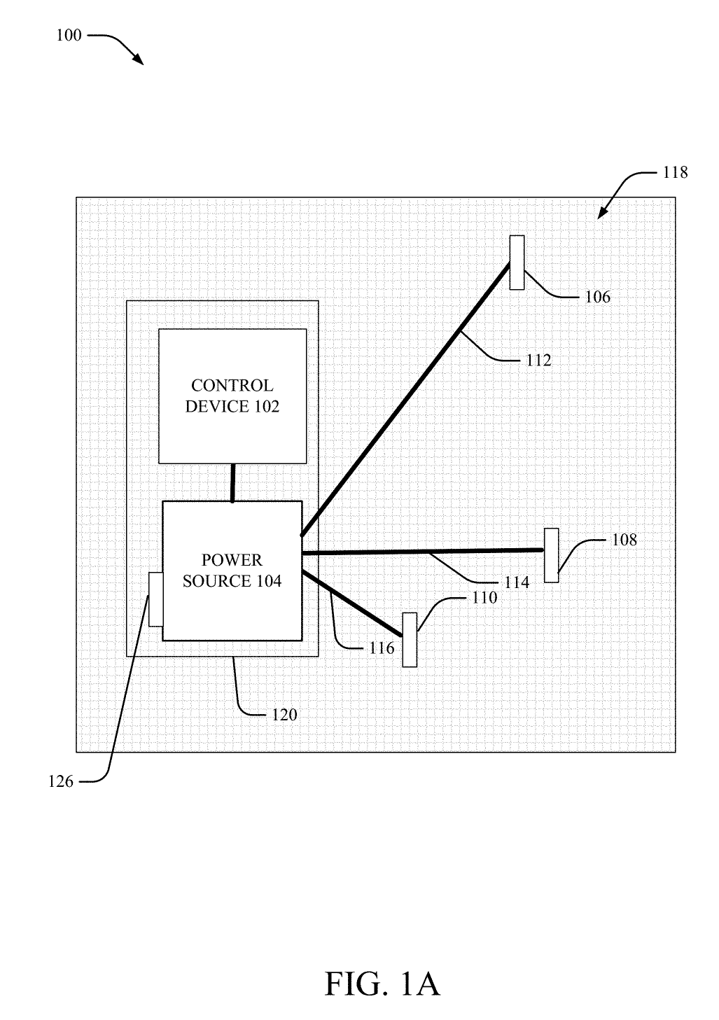

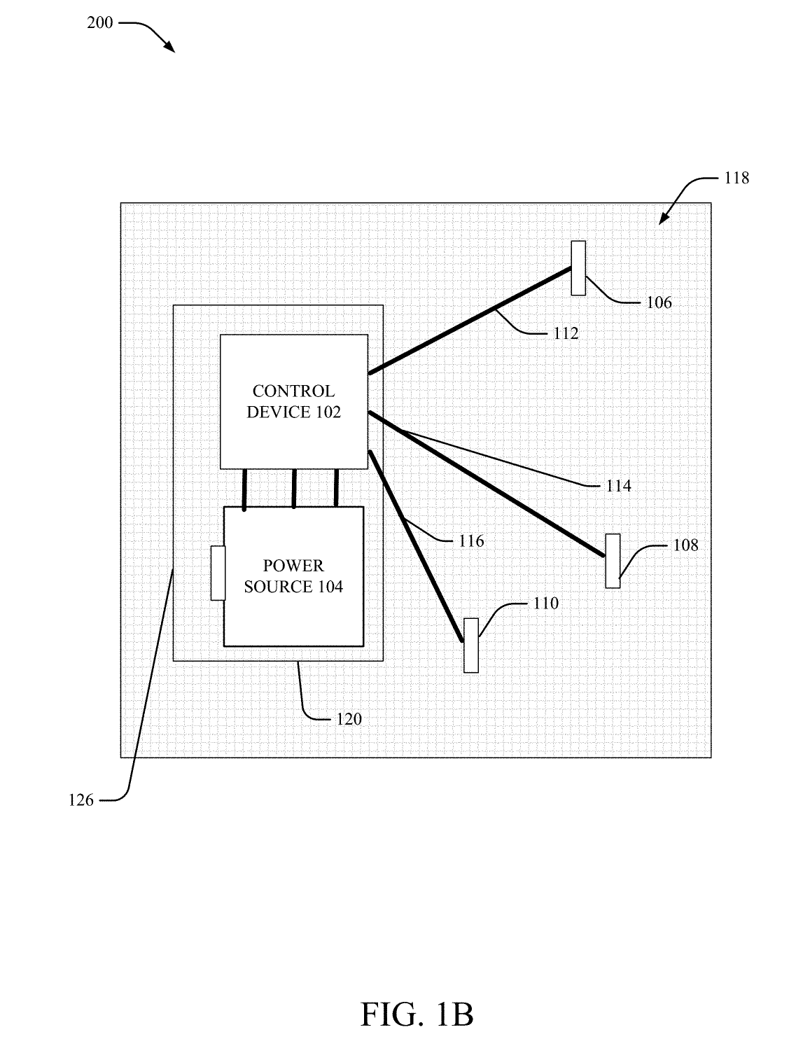

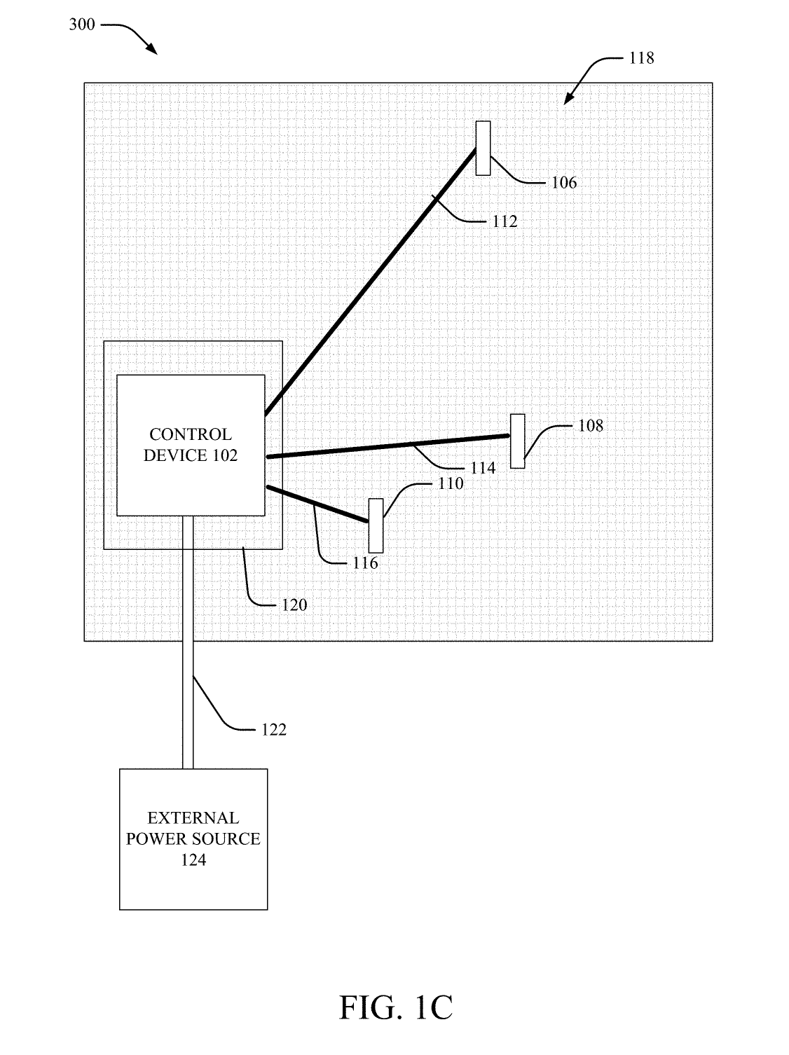

FIGS. 1A, 1B, and 1C illustrate example, non-limiting partial views of schematic diagrams of IEBSs (e.g., 100, 200, 300) in accordance with one or more embodiments described herein. Repetitive description of like elements employed in other embodiments described herein is omitted for sake of brevity.

The partial views of the IEBSs 100, 200, 300 can be a view showing various components of the IEBSs 100, 200, 300 including control device, power source 104 and/or one or more illumination elements 106, 108, 110. As shown, the control device 102, power source 104 and/or one or more illumination elements 106, 108, 110 can be electrically and/or communicatively coupled to one another to perform one or more functions of the IEBSs 100, 200, 300.

In some embodiments, the illumination elements 106, 108, 110 can be or include light emitting diodes (LEDs), light bulbs or any other component configured to become illuminated upon receipt of power. Any number of different technologies can be employed that provide illumination and are envisaged within the scope of this disclosure.

The power source 104 can be removable from the IEBSs 100, 200 in some embodiments to allow the IEBSs 100, 200 to be washed or dry cleaned. For example, in some embodiments, the power source 104 can be plugged/unplugged into the control device 102 and/or the IEBS 100, 200, 300 in general. In some embodiments, the power source 104 can include a switch 126 that can allow the power source 104 to be manually turned on or off (e.g., by a human, for example).

In various embodiments, the power source 104 can include one or more batteries (e.g., a battery pack) in various embodiments. In other embodiments, the power source 104 can be other sources of power, including, but not limited to, solar cells charged by removing the power source 104 from the IEBS 100, 200 and providing allowing sunlight to be applied to the solar cells. All such embodiments are envisaged.

Further, in some embodiments, such as IEBS 300, the control device 102 can be coupled to an electrical connection 302 (e.g., electrical cord) configured to enable the control device to receive power from an external power source 124 (e.g., an electrical outlet, a battery pack or the like).

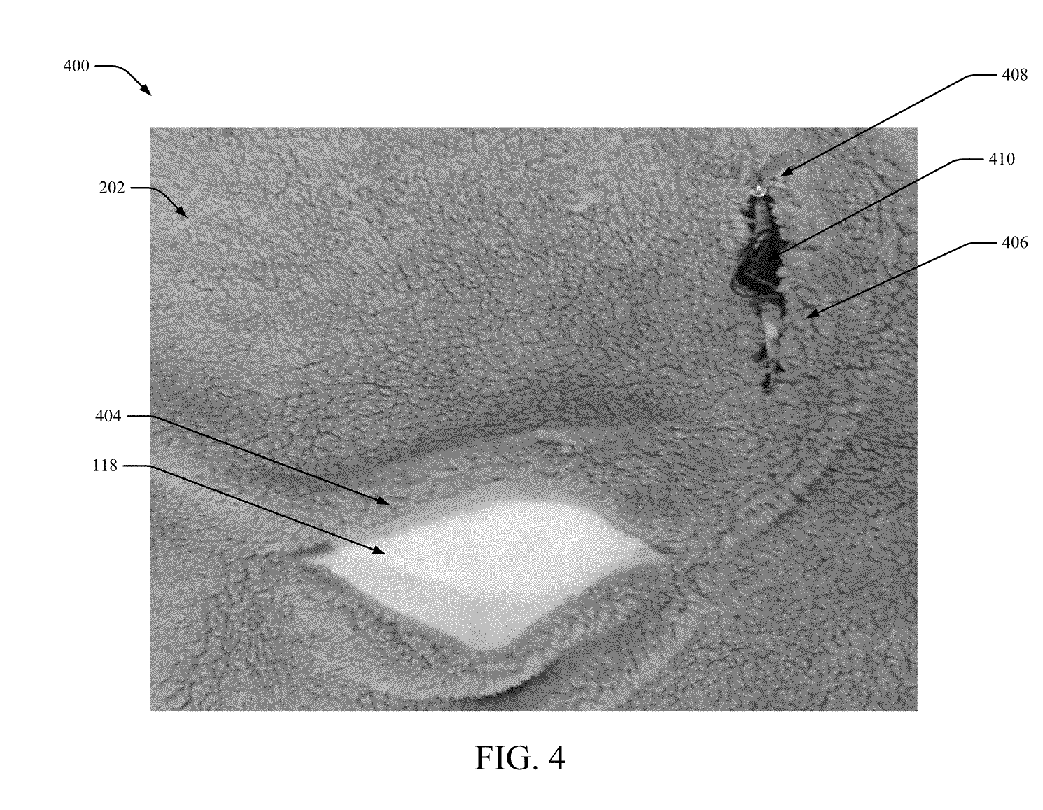

Shown is a top down view, and from this view, the control device, power source 104 and/or one or more illumination elements 106, 108, 110 can be disposed over or on (or, in some embodiments, through) the layer 118 of fabric. The partial view shows the IEBSs 100, 200, 300 open with the first layer of fabric (not shown) removed. The first layer of fabric can be as shown as 402 in FIGS. 4, 5, 6 and 7 described herein. The layer 118 of fabric can be an inner layer of fabric shown in FIGS. 4, 5, 6 and 7. The control device 102 and/or the power source 104 can be provided inside of a pouch 120 in some embodiments, as shown in one or more of IEBS 100, 200, 300. While the term “blanket” is used herein (esp. with reference to IEBS) in various embodiments, any throw or other fabric can be employed herein as an illumination element system having illumination elements dispersed throughout and all such embodiments are envisaged.

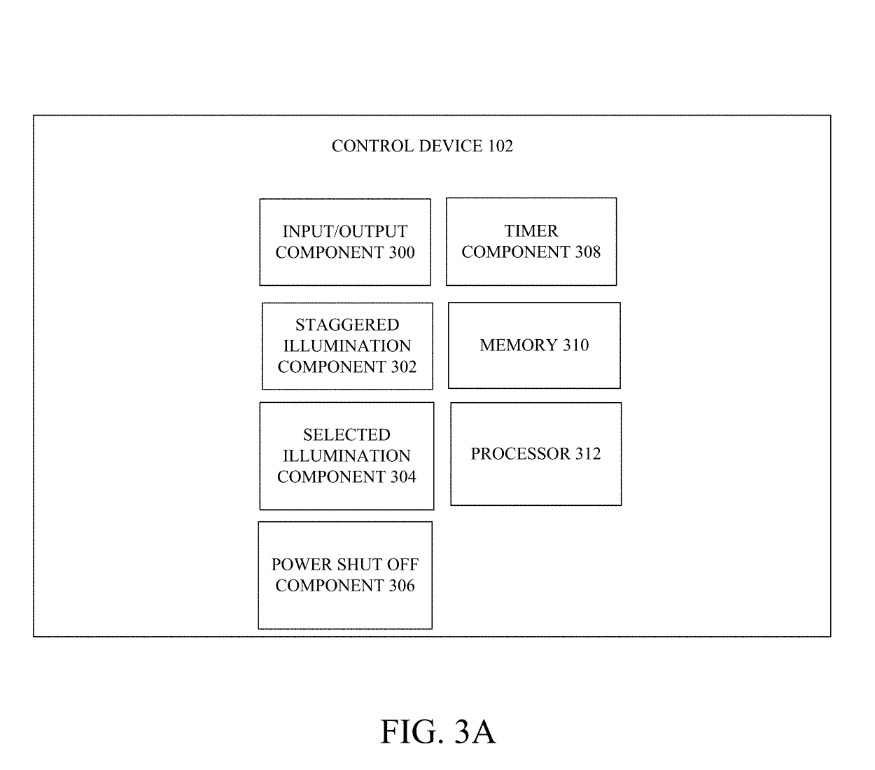

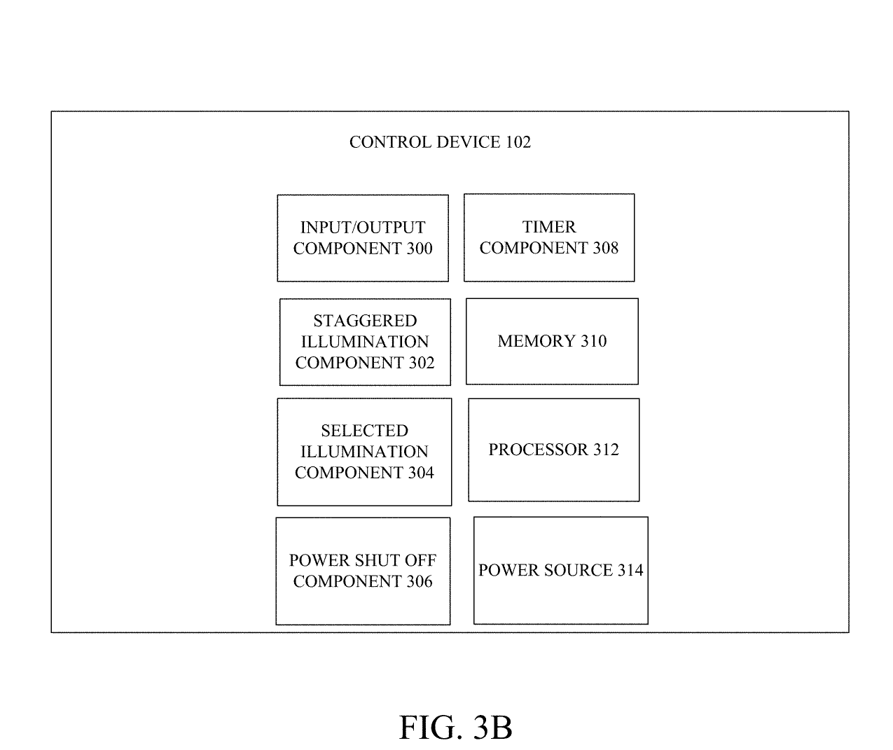

As shown in FIGS. 1A, 1B, 1C, there can be numerous different approaches to connecting the power source 104, control device 102 and/or one or more illumination elements 106, 108, 110 to control illumination of the IEBS 100, 200, 300. These approaches will be described in more detail with reference to the control device of FIGS. 3A and 3B. FIGS. 3A and 3B illustrate example, non-limiting block diagrams of a control device of an IEBS in accordance with one or more embodiments described herein. In some embodiments, the control device 102 can be or can include an integrated circuit/chip to perform one or more of the functions of the control device 102.

As shown in FIG. 3A, control device 102 can comprise an input/output (I/O) component 300 configured to output one or more signals to the power source 104 for control of the power source (and/or control of illumination of the illumination elements 106, 108, 110 via the power source 104). In some embodiments, the I/O component 300 can receive one or more signals from the power source 104. In some embodiments, the I/O component 300 can include a power supply cable to power the control device. The control device 102 can also include a staggered illumination component 302 and/or selected illumination component 304 that can generate one or more signals to the power source 104 causing the power source 104 to output power to particular electrical connections connected to illuminated elements that are to be illuminated. The staggered illumination component can output signals causing the illumination of the illumination elements 106, 108, 110 to be staggered in a particular pattern or manner and the selected illumination component can output signals causing one or more illumination elements 106, 108, 110 to be concurrently illuminated (e.g., either for the entire time the power source 104 is connected to the IEBS 100, 200, 300 or for a defined amount of time).

The power shut off component 306 can control the power source 104 to power down. In some embodiments, the power shut off component 306 can control the power source to automatically (without human intervention) shut down after a defined amount of time that the power source 104 has been turned on. Accordingly, in some embodiments, the timer component 308 can track a time that the power source 104 has been turned on and generate a signal causing the control device 104 to output a signal for turning the power source 104 when a defined amount of time has passed that the power source 104 has been turned on.

As shown in FIG. 3B, in some embodiments, the control device 102 can comprise its own power source 314 enabling the control device 102 to power up or power down without separate power source 104. In some embodiments, the power source 104 can be the power source 314 and therefore can reside within the control device 102.

With reference to FIGS. 3A and 3B, the memory 310 can comprise computer-executable instructions that can be executed by the processor 312. For example, the computer executable instructions can include patterns for staggered illumination or information for selected illumination (e.g., the information for selected illumination can comprise information forming a particular design relative to printing on the first layer or otherwise when one or more of the illumination elements 106, 108, 110 are illuminated, for example).

With reference to FIGS. 1A, 3A, 3B, the control device 102 and each of the illumination elements 106, 108, 110 are electrically connected to the power source 104 to receive power from the power source 104. Upon receiving power from the power source 104, one or more of the illumination elements 106, 108, 110 can become illuminated. As shown, the electrical connections 112, 114, 116 between the power source 104 and the respective illumination elements 106, 108, 110 can be separate in some embodiments so as to enable the power source 104 to provide power to only selected ones of the illumination elements 106, 108, 110 at any particular time. Accordingly, each of the electrical connections 112, 114, 116 can be connected to a particular illumination element. For example, in some embodiments, the control device 104 can generate a signal that can be received by the power source 104 causing the power source 104 to turn on or off designated ones of the illumination elements 106, 108, 110 (e.g., via the staggered illumination component 302 or the selected illumination component 304).

Thus, in some embodiments, the power source 104 can provide power to all illumination elements 106, 108, 110 to cause all illumination elements 106, 108, 110 to become illuminated concurrently while at other times, the illumination may be generated at only a subset of illumination elements 106, 108, 110 based on power being provided from the power source 104 to that corresponding subset of illumination elements 106, 108, 110.

In some embodiments, the power supply 104 can provide power in a staggered manner in the illumination elements 106, 108, 110 are provided power in a particular pattern or order to cause the illumination elements 106, 108, 110 to become illuminated and then turn off (when power ceases to be provided to that particular one of the illumination elements 106, 108, 110 by the power source 104). Accordingly, in different embodiments, different patterns of illumination between one or more of the illumination elements 106, 108, 110 over time can be displayed via the IEBSs 100, 200, 300.

With reference to FIGS. 1B, 3A, 3B, the control device 102 and each of the illumination elements 106, 108, 110 are electrically connected to one another and the control device 102 is connected to the power source 104 to receive power from the power source 104 and to control illumination of one or more of the illumination elements 106, 108, 110.

With reference to FIGS. 1C, 3A, 3B, the control device 102 and each of the illumination elements 106, 108, 110 are electrically connected to one another and the control device 102 is connected to the external power source 124 to receive power from the external power source 124 and to control illumination of one or more of the illumination elements 106, 108, 110.

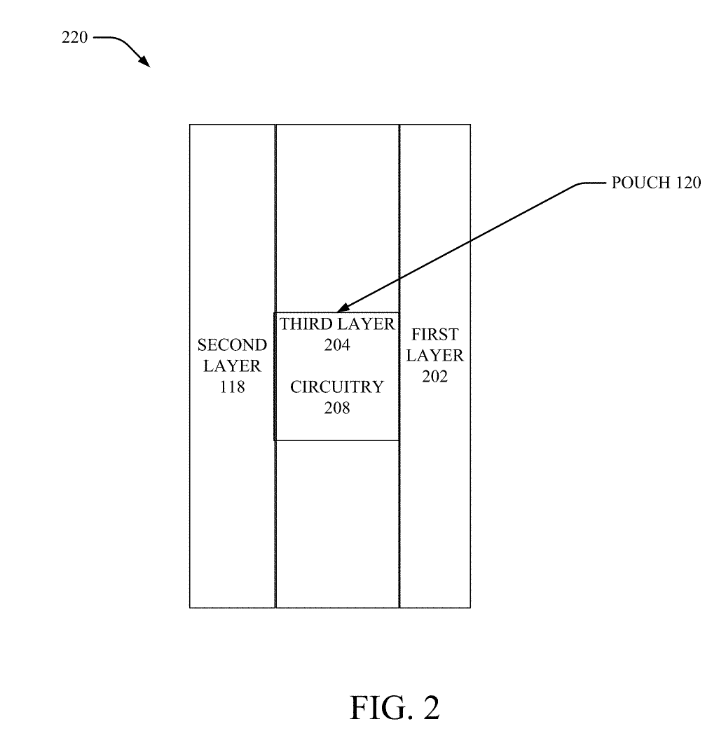

FIG. 2 illustrates an example, non-limiting schematic diagram of a side view of an illumination element blanket system in accordance with one or more embodiments described herein. Repetitive description of like elements employed in other embodiments described herein is omitted for sake of brevity.

As shown, the first layer 202 can be an outer layer of the IEBS 100, 200, 300 and can be any suitable fabric for a blanket, throw or covering including, but not limited to, velveteen, wool, acrylic, polyester, cotton, sherpa or the like. In some embodiments, the first layer 202 can be a printed top layer with lining shown as the second layer 118.

In some embodiments, a third layer 204 of fabric can be provided and/or formed as a pouch 120. In some embodiments, the third layer 204 can be a waterproof material. In other embodiments, the second layer 118 and/or the third layer 204 can be a nonwoven fabric. In various embodiments, the third layer 204 can be any thin, lightweight and stable fabric.

As shown, inside of the pouch 120 can be circuitry 208. As used herein, the term “circuitry” can include in whole or in part, but is not limited to, power source 104, control device 102, one or more integrated circuits/chips that perform one or more functions, electrical connections 112, 114, 116, an electrical connector 122 and/or one or more illumination elements 106, 108, 110. Although not shown, the illumination elements 106, 108, 110 can be dispersed through or attached to (e.g., via adhesive, sewn via thread or otherwise) one or more of the first layer 202, second layer 118 and/or third layer 204 or pouch 120. In some embodiments, one or more of illumination elements 106, 108, 110 can be glued to the third layer 204 of fabric inside the IEBS 100, 200, 300, 220.

FIGS. 4, 5, 6 and 7 illustrate example, non-limiting photographs of an IEBS 400 having a hole disposed through an outer layer of fabric revealing inside construction and selected components in accordance with one or more embodiments described herein. In various embodiments, the structure and/or functionality of IEBS 400 can be or include that shown and/or described with reference to IEBSs 100, 200, 300. Repetitive description of like elements employed in other embodiments described herein is omitted for sake of brevity.

FIG. 4 shows a first layer 402 (e.g., outer layer) of fabric and a second layer 118 (e.g., inner layer) of fabric of the IEBS 100. In some embodiments, the second layer 118 can be a lining while the first layer 402 can be sherpa, wool, cotton, polyester, acrylic or any number of other fabrics. The IEBS 100 is detailed with a hole 404 disposed through the first layer 402 to exhibit the inside construction of the IEBS 100. In particular, at the first hole 404 shown is the second layer of fabric 118. Shown is an open portion 406 that can be closed by a zipper 408 (or any other component configured to close an open area at least partially, including, but not limited to, buttons, snap fasteners, hook and look structures and the like). In some embodiments, the circuitry is located within a pouch (120 with reference to FIGS. 1A, 1B, 1C, 2) having the zipper 408 (or other component configured to close an open area) positioned to close the pouch (120 with reference to FIGS. 1A, 1B, 1C, 2). Shown are electrical connections 410 (e.g., wires). In some embodiments, only the power supply 104 is provided within the pouch. In some embodiments, the power supply 104 can be removable from the IEBS 100 to facilitate washing at least the fabric the blanket.

In various embodiments, any one of the control device (102 with reference to FIGS. 1A, 1B, 1C, 3A, 3B), power source (e.g., 104 with reference to FIGS. 1A, 1B, 1C) and/or one or more illumination elements (e.g., 106, 108, 110 with reference to FIGS. 1A, 1B, 1C) can be provided in the open portion 406. Although not shown, the pouch can include the power source (104 with reference to FIG. 1) an a third layer (not shown) of fabric (e.g., non-woven fabric) that can layer be between the electrical connections 410 and the second layer 118. In some embodiments, the third layer can be a waterproof layer.

In other embodiments, numerous pouches can be provided for containing the control device 102, power source 104 and/or the like. In some embodiments, no pouch need be included in the IEBS 100 and the control device 102 and/or power supply 104 can be couple to the first layer 402 or the second layer 118. In some embodiments, the pouch can be formed of a third layer (not shown) and can be disposed between the first layer 402 and the second layer 118. In some embodiments, illumination elements (not shown) can be disposed through and/or on the first layer 402 and/or the second layer 118.

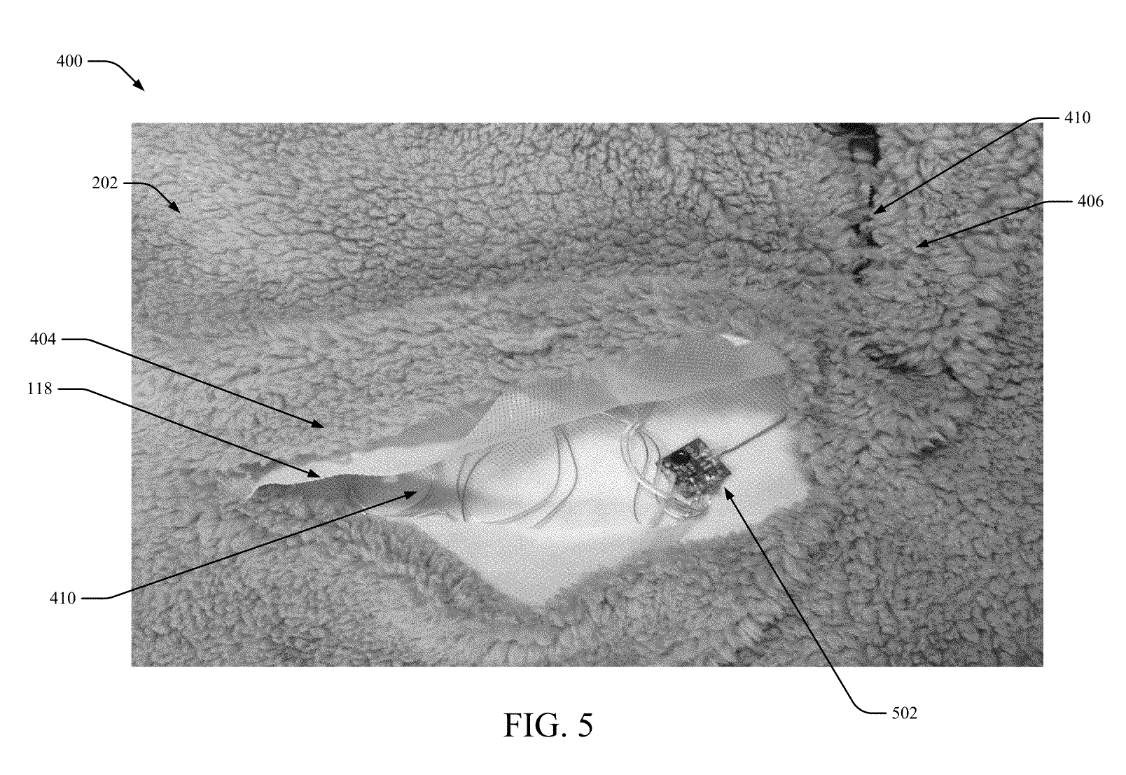

Turning now to FIG. 5, shown are electrical connections 410 (e.g., wires) leading from the power source (e.g., battery pack) (not shown in FIG. 5) to an integrated circuit/chip 502. The electrical connections 410 then connect to the illumination elements (e.g., LEDs) (not shown in FIG. 5). The integrated circuit/chip 502 can be glued to the inside layer of the second layer 118 of fabric (e.g., the second layer 118 can be nonwoven fabric in this embodiment, although other fabrics can be employed in other embodiments.

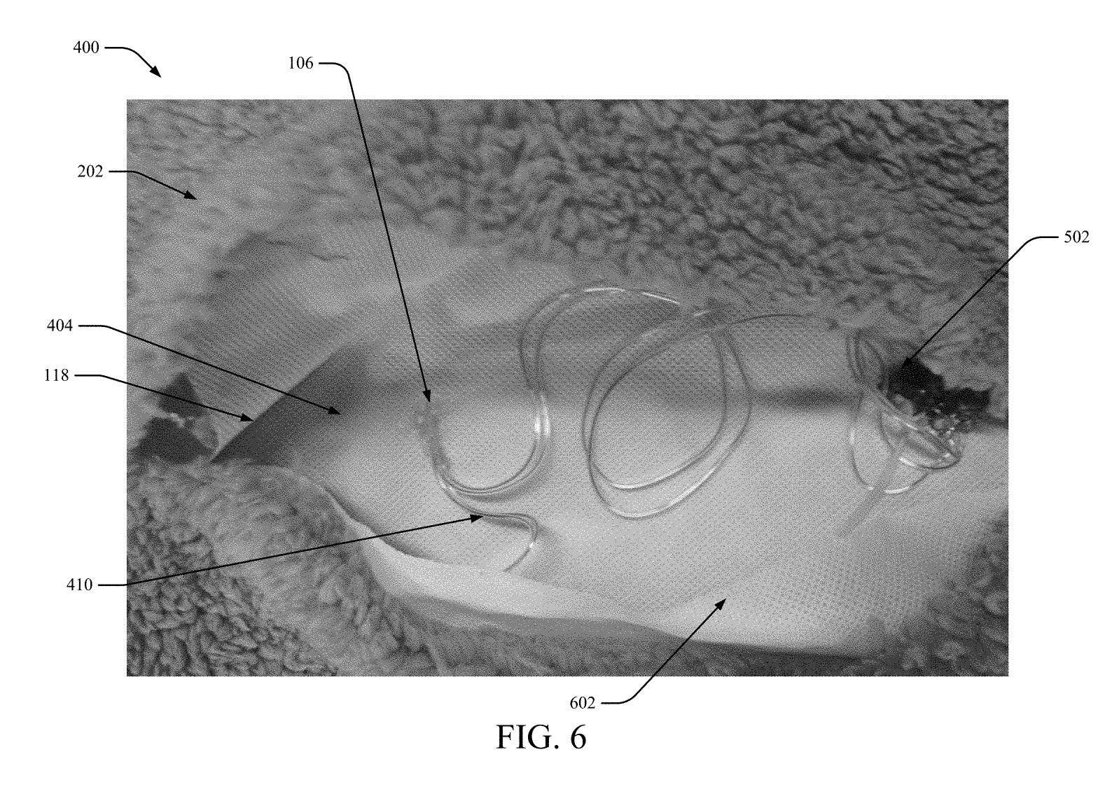

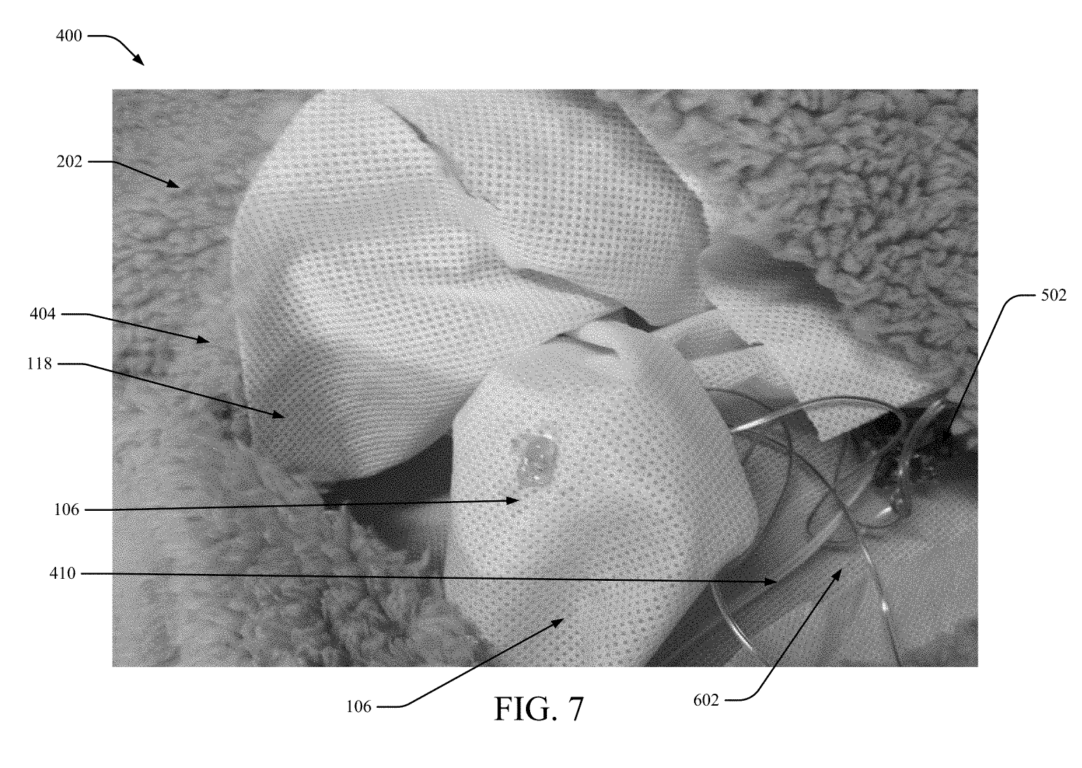

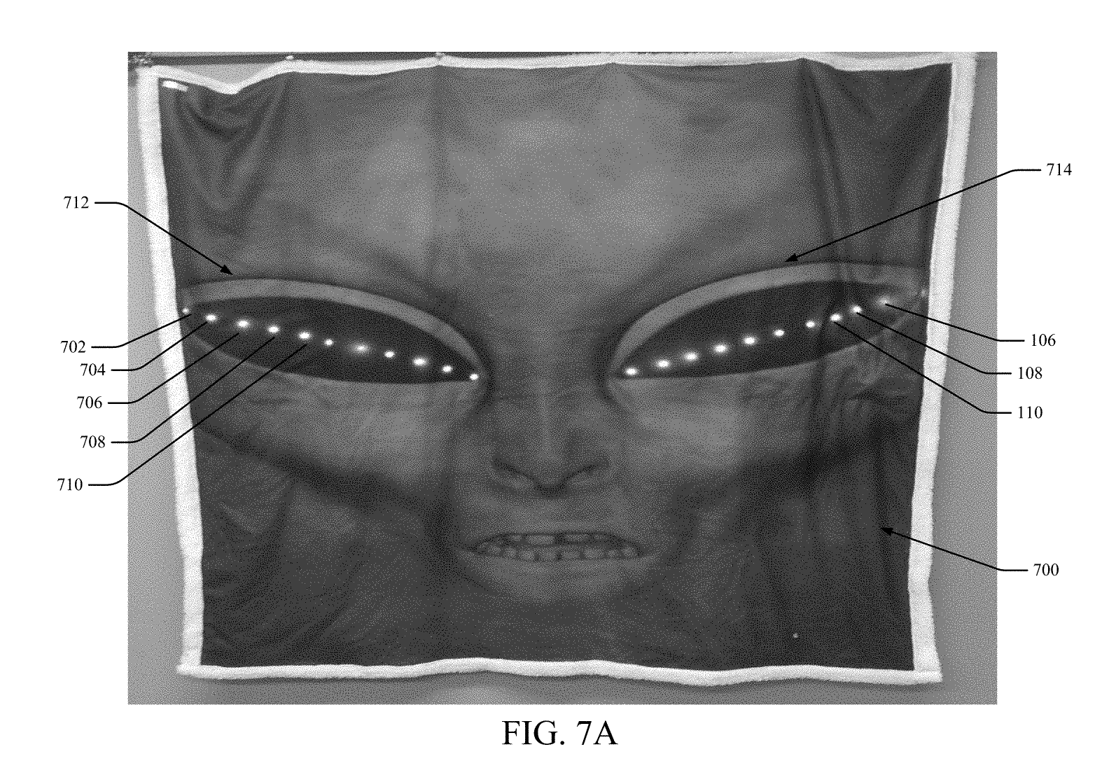

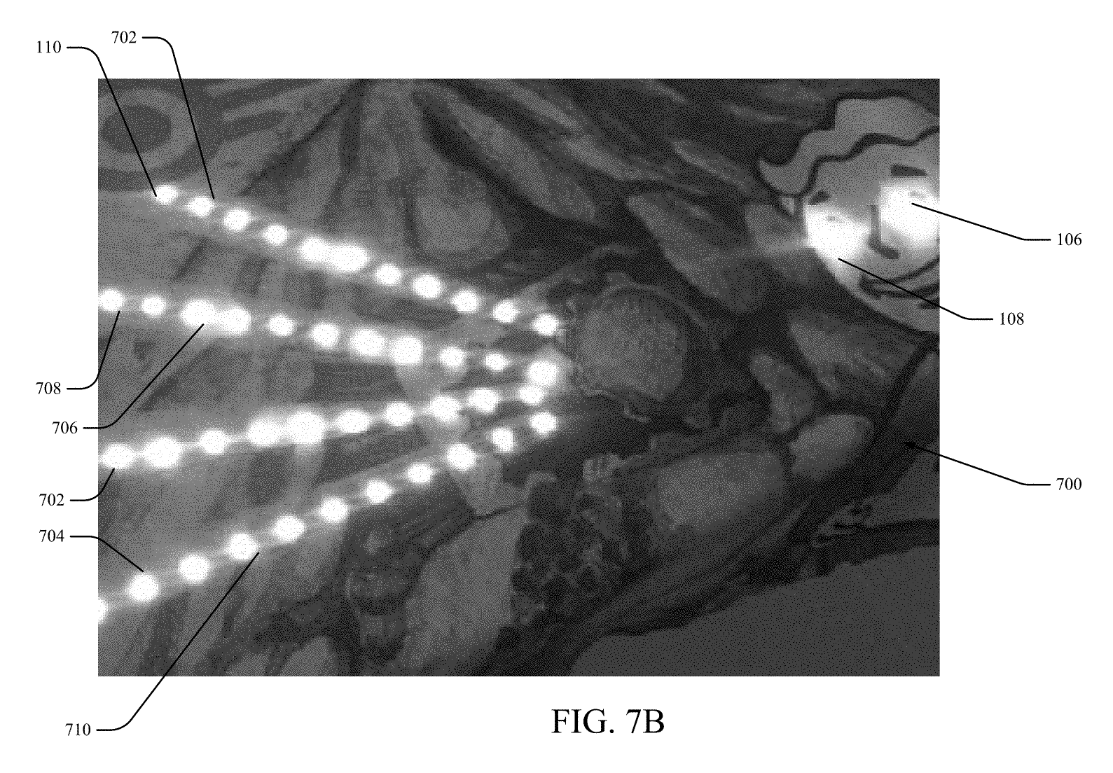

Turning now to FIG. 6, shown is an embodiment of IEBS 100 having an illumination element 106 pushed through a small hole in the second layer fabric 118 and glued on both sides of the second layer of fabric 118 (shown is the illumination element 106 glued on a first side 602 of the second layer 118 of fabric). In FIG. 7, shown is the illumination element glued on the other side 702 of the second layer 118 of fabric.

FIG. 7A illustrates an example, non-limiting photograph of an IEBS 400 showing illumination of illumination elements 106, 108, 110 viewable through the first layer 202. The first layer 202 includes a printed fabric 700 having the illumination elements 106, 108, 110 provided through the holes in the printed fabric 700. For example, in FIG. 7A, the illumination elements 106, 108, 110 can be provided through holes in the printed fabric 700 in a configuration providing a design that is complementary to the design of the printed fabric 700. By way of example, but not limitation, the illumination elements 106, 108, 110 are positioned within the eyes of a face printed on the printed fabric 700 to provide illumination of the structure of the eyes 712, 714. In some other embodiments, the illumination elements 106, 108, 110 can be provided in any number of different configurations to illustrate different lighted designs and/or to display different shapes or structures of lighted objects. As such, the illumination elements 106, 108, 110 can be placed to correspond with the design printed on the first layer 202 of the printed fabric 700. In some embodiments, the illumination elements 106, 108, 110 can be placed to correspond to a design on the printed fabric while in some embodiments, one or more the illumination elements 106, 108, 110 can be placed to form designs and/or objects (e.g., regular polygons, irregular polygons, swirl design elements, objects formed from combining one or more polygons, commonplace objects (e.g., houses, cars, people). For example, in FIG. 7B, numerous illumination elements (e.g., illumination elements 106, 108, 110, 702, 704, 706, 708, 710, etc.) can be positioned to form a design on the printed fabric 700 (e.g., a design of power rays emanating from a character on the printed fabric 700 while other illumination elements can be employed as part of the design printed on the printed fabric 700 (e.g., illumination elements 106, 108 providing light from the eye design on the printed blanket). Thus, in some embodiments, the illumination elements can be positioned as part of a pre-printed design or can form a design in various different embodiments. All such embodiments are envisaged.

Although in embodiments described herein only various illumination elements are labeled (e.g., 106, 108, 110, 702, 704, 706, 708, 710) in some embodiments, any number of illumination elements can be provided as part of the IEBS 400 and all such embodiments are envisaged.

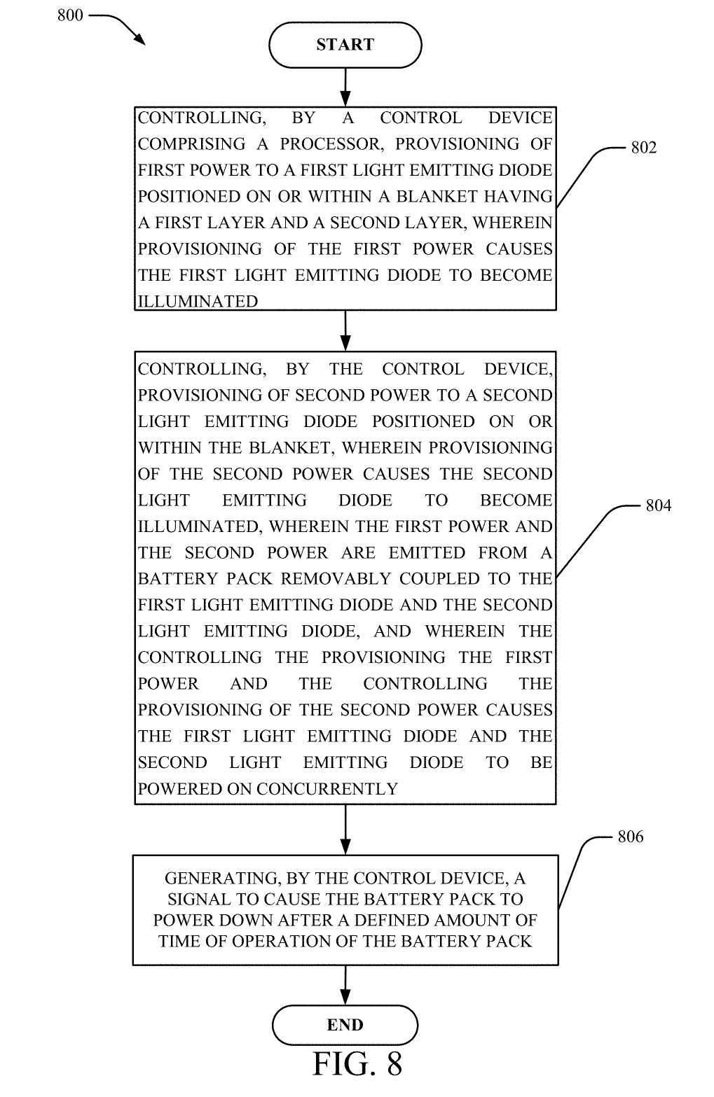

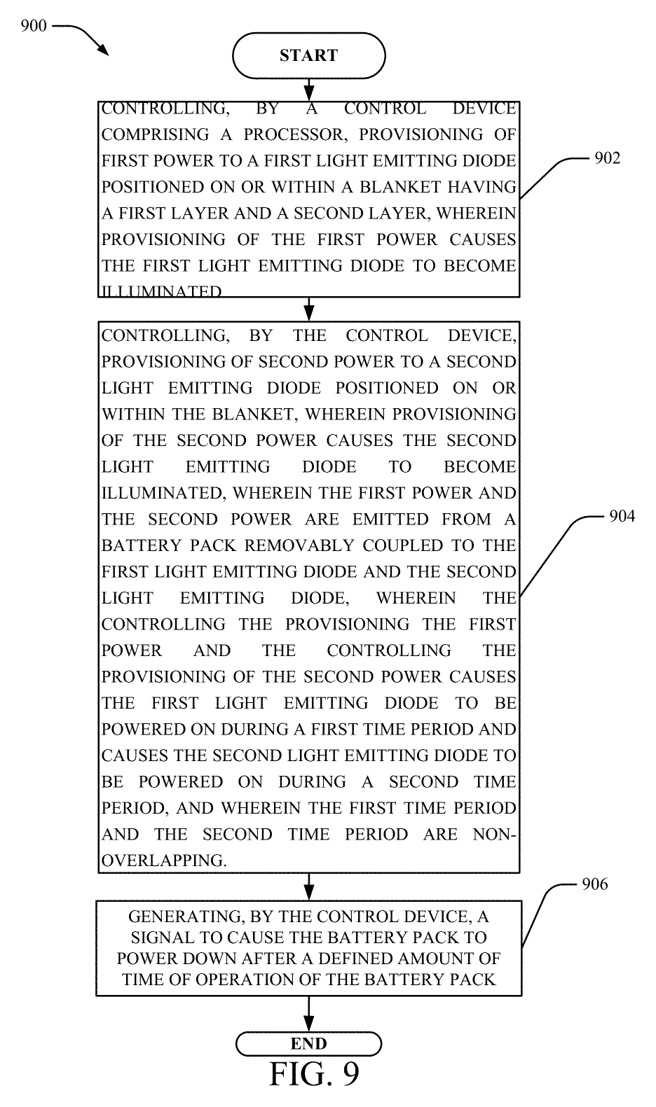

FIGS. 8 and 9 illustrate flow charts of methods of operation of an illumination element blanket system in accordance with one or more embodiments described herein. Repetitive description of like elements employed in other embodiments described herein is omitted for sake of brevity.

Turning first to FIG. 8, at 802, method 800 can comprise controlling, by a control device (e.g., control device 102), provisioning of first power to a first light emitting diode positioned on or within a blanket having a first layer and a second layer, wherein provisioning of the first power causes the first light emitting diode to become illuminated.

At 804, method 800 can comprise controlling, by the control device (e.g., control device 102), provisioning of second power to a second light emitting diode positioned on or within the blanket, wherein provisioning of the second power causes the second light emitting diode to become illuminated, wherein the first power and the second power are emitted from a battery pack removably coupled to the first light emitting diode and the second light emitting diode, wherein controlling the provisioning the first power and the controlling the provisioning of the second power causes the first light emitting diode and the second light emitting diode to be powered on concurrently.

In some embodiments, method 800 can also comprise, at 806, generating, by the control device, a signal to cause the battery pack to power down after a defined amount of time of operation of the battery pack.

Turning now to FIG. 9, at 902, method 900 can comprise controlling, by a control device, provisioning of first power to a first light emitting diode positioned on or within a blanket having a first layer and a second layer, wherein provisioning of the first power causes the first light emitting diode to become illuminated.

At 904, method 900 can comprise controlling, by the control device, provisioning of second power to a second light emitting diode positioned on or within the blanket, wherein provisioning of the second power causes the second light emitting diode to become illuminated, wherein the first power and the second power are emitted from a battery pack removably coupled to the first light emitting diode and the second light emitting diode, wherein controlling the provisioning the first power and the controlling the provisioning of the second power causes the first light emitting diode to be powered on during a first time period and causes the second light emitting diode to be powered on during a second time period, wherein the first time period and the second time period are non-overlapping.

In some embodiments, method 900 can also comprise, at 906, generating, by the control device, a signal to cause the battery pack to power down after a defined amount of time of operation of the battery pack.

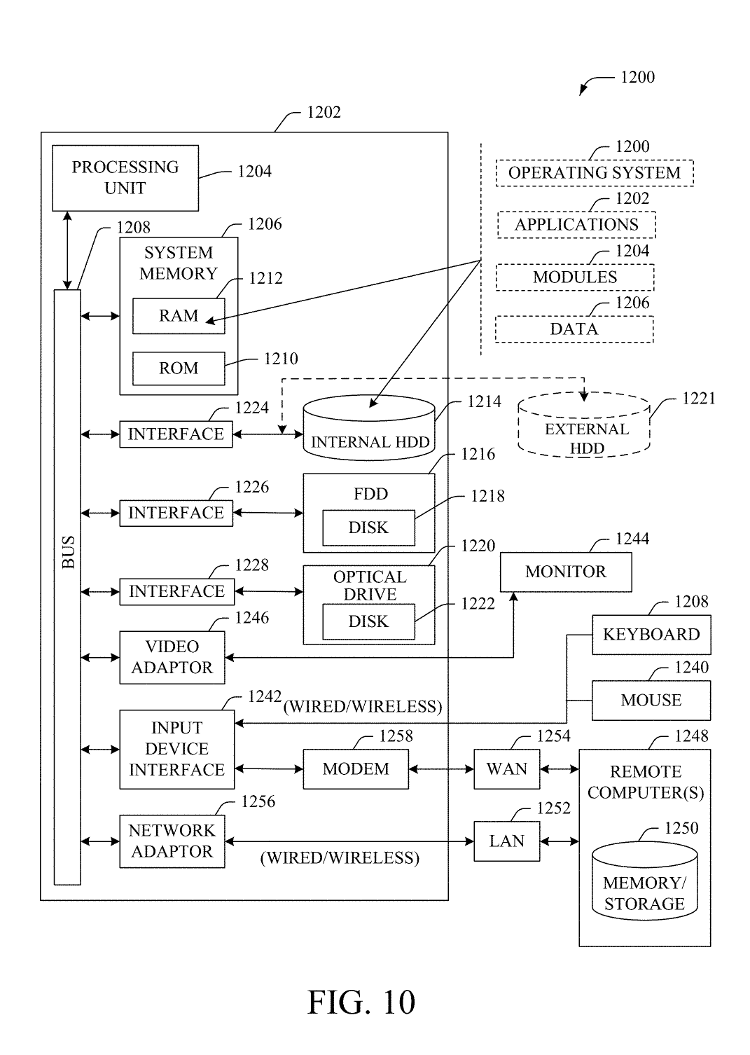

FIG. 10 illustrates a block diagram of a computer that can be employed in accordance with one or more embodiments. Repetitive description of like elements employed in other embodiments described herein is omitted for sake of brevity. In some embodiments, the computer, or a component of the computer, can be or be comprised within any number of components described herein comprising, but not limited to, LED blanket system 100, 200, 300, control device 102, power source 104, illumination devices 106, 108, 110 (or components of LED blanket system 100, 200, 300, control device 102, power source 104, illumination devices 106, 108, 110).

In order to provide additional text for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable (or machine-readable) storage media and/or communications media, which two terms are used herein differently from one another as follows. Computer-readable (or machine-readable) storage media can be any available storage media that can be accessed by the computer (or a machine, device or apparatus) and comprises both volatile and nonvolatile media, removable and non-removable media. By way of example, and not limitation, computer-readable (or machine-readable) storage media can be implemented in connection with any method or technology for storage of information such as computer-readable (or machine-readable) instructions, program modules, structured data or unstructured data. Tangible and/or non-transitory computer-readable (or machine-readable) storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable (or machine-readable) storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable (or machine-readable) media, is to be understood to exclude only propagating intangible signals per se as a modifier and does not relinquish coverage of all standard storage, memory or computer-readable (or machine-readable) media that are not only propagating intangible signals per se.

In this regard, the term “non-transitory” herein as applied to storage, memory or computer-readable (or machine-readable) media, is to be understood to exclude only propagating transitory signals per se as a modifier and does not relinquish coverage of all standard storage, memory or computer-readable (or machine-readable) media that are not only propagating transitory signals per se.

Communications media typically embody computer-readable (or machine-readable) instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 10, the example environment 1000 for implementing various embodiments of the embodiments described herein comprises a computer 1002, the computer 1002 comprising a processing unit 1004, a system memory 1006 and a system bus 1008. The system bus 1008 couples system components comprising, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 comprises ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also comprise a high-speed RAM such as static RAM for caching data.

The computer 1002 further comprises an internal hard disk drive (HDD) 1010 (e.g., EIDE, SATA), which internal hard disk drive 1014 can also be configured for external use in a suitable chassis (not shown), a magnetic floppy disk drive 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface, respectively. The interface 1024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable (or machine-readable) storage media provide nonvolatile storage of data, data structures, computer-executable instructions, and so forth. For the computer 1002, the drives and storage media accommodate the storage of any data in a suitable digital format. Although the description of computer-readable (or machine-readable) storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, comprising an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A communication device can enter commands and information into the computer 1002 through one or more wired/wireless input devices, e.g., a keyboard 1038 and a pointing device, such as a mouse 1040. Other input devices (not shown) can comprise a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. In addition to the monitor 1044, a computer typically comprises other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a first, a personal computer, portable computer, microprocessor-based entertainment appliance, a peer device or other common network node, and typically comprises many or all of the elements described relative to the computer 1002, although, for purposes of brevity, only a memory/storage device 1050 is illustrated. The logical connections depicted comprise wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1052 through a wired and/or wireless communication network interface or adapter 1056. The adapter 1056 can facilitate wired or wireless communication to the LAN 1052, which can also comprise a wireless AP disposed thereon for communicating with the wireless adapter 1056.

When used in a WAN networking environment, the computer 1002 can comprise a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.11 or Ethernet). Wi-Fi networks operate in the unlicensed 2.4 and 5 GHz radio bands, at an 10 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a communication device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing communication device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of communication device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable (or machine-readable) storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above comprises mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

What is claimed is:

1. An article of manufacture, comprising:
a first layer of fabric;
a second layer of fabric; and
circuitry disposed between the first layer of fabric and the second layer of fabric, the circuitry comprising:
at least one light emitting diode; and
a control device coupled to the at least one light emitting diode, wherein the control device is configured to control illumination of the at least one light emitting diode.

2. The article of manufacture of claim 1, wherein the article of manufacture further comprises a power source coupled to the control device and configured to provide power to the control device and the at least one light emitting diode.

3. The article of manufacture of claim 2, wherein the power source is removably coupled to the circuitry.

4. The article of manufacture of claim 2, wherein the power source comprises a battery pack.

5. The article of manufacture of claim 2, wherein the battery pack is configured with a switch that controls the battery pack to provide power to the control device and the at least one light emitting diode.

6. The article of manufacture of claim 1, further comprising a power connection component coupled to the control device, wherein the power connection component is configured to be removably coupled to a power source external to the article of manufacture to provide power to the control device and the at least one light emitting diode.

7. The article of manufacture of claim 1, further comprising at least one other light emitting diode, wherein the control device is configured to output a signal causing the at least one light emitting diode and the at least one other light emitting diode to have staggered illumination, wherein the staggered illumination comprises the at least one light emitting diode commencing illuminating at a first time and the at least one other light emitting diode commencing illumination at a second time, wherein the second time is later than the first time.

8. The article of manufacture of claim 7, wherein the control device is configured to output a signal causing the at least one light emitting diode and the at least one other light emitting diode to illuminate.

9. The article of manufacture of claim 1, wherein the control device comprises a power shut off component configured to automatically shut off power from the battery pack.

10. The article of manufacture of claim 10, wherein the power shut off component is further configured to automatically shut off power from the battery pack after a defined amount of time that the battery pack has been turned on.

11. The article of manufacture of claim 1, wherein the first layer of fabric is an outer layer of fabric that comprises at least one of sherpa, velveteen, fleece, wool, acrylic, cotton or polyester.

12. The article of manufacture of claim 1, further comprising:
a third layer of fabric positioned between the first layer and the second layer, wherein the light emitting diode is attached to the third layer of fabric.

13. The article of manufacture of claim 14, wherein the light emitting diode is attached to the third layer of fabric via adhesive.

14. A method, comprising:
controlling, by a control device comprising a processor, provisioning of first power to a first light emitting diode positioned on or within a blanket having a first layer and a second layer, wherein provisioning of the first power causes the first light emitting diode to become illuminated; and
controlling, by the control device, provisioning of second power to a second light emitting diode positioned on or within the blanket, wherein provisioning of the second power causes the second light emitting diode to become illuminated, wherein the first power and the second power are emitted from a battery pack removably coupled to the first light emitting diode and the second light emitting diode.

15. The method of claim 14, wherein the controlling the provisioning the first power and the controlling the provisioning of the second power causes the first light emitting diode and the second light emitting diode to be powered on concurrently.

16. The method of claim 14, wherein the controlling the provisioning the first power and the controlling the provisioning of the second power causes the first light emitting diode to be powered on during a first time period and causes the second light emitting diode to be powered on during a second time period, wherein the first time period and the second time period are non-overlapping.

17. The method of claim 14, further comprising:
generating, by the control device, a signal to cause the battery pack to power down after a defined amount of time of operation of the battery pack.

18. A system, comprising:
a fabric having a plurality of illumination elements configured to illuminate and disposed on or within the fabric; and
a power source coupled to a plurality of electrical connections respectively coupled to the plurality of illumination elements to provide power to the illumination elements, wherein the power source is configured to illuminate one or more of the plurality of illumination elements concurrently.

19. The system of claim 18, wherein the power source is coupled to a switch that causes the power source to provide power to one or more of the plurality of illumination elements and to cease providing power to the one or more of the plurality of illumination elements.

20. The system of claim 18, wherein the illumination elements are light emitting diodes.
